(19) United States
(12) Patent Application Publication
(10) Pub. No.: US 2018/0356885 A1
(43) Pub. Date: Dec. 13, 2018

(54) SYSTEMS AND METHODS FOR DIRECTING ATTENTION OF A USER TO VIRTUAL CONTENT THAT IS DISPLAYABLE ON A USER DEVICE OPERATED BY THE USER

(71) Applicant: Tsunami VR, Inc., Del Mar, CA (US)

(72) Inventors: David ROSS, San Diego, CA (US); Beth BREWER, Escondido, CA (US)

(21) Appl. No.: 16/000,839

(22) Filed: Jun. 5, 2018

Related U.S. Application Data
(60) Provisional application No. 62/517,910, filed on Jun. 10, 2017.
(60) Provisional application No. 62/528,511, filed on Jul. 4, 2017.

(51) Int. Cl. G06F 3/01; G06T 19/00; G06F 3/0481; G06F 3/0484; G06F 3/16

(52) U.S. Cl. CPC G06F 3/013; G06T 19/006; G06F 3/04842; G06F 3/04845; G06F 3/167; G06F 3/04815

(57) ABSTRACT

Directing attention of a user to virtual content that is displayable on a user device operated by the user. Particular methods and systems perform the following steps: determining if a first user operating a first user device is looking at first virtual content; and if the first user is not looking at the first virtual content, directing attention of the first user to the first virtual content. Different approaches for directing the attention of the first user are described.

### RELATED APPLICATIONS

This application relates to the following related application(s): U.S. Pat. Appl. No. 62/517,910, filed Jun. 10, 2017, entitled METHOD AND SYSTEM FOR FORCING ATTENTION ON AN OBJECT OR CONTENT PRESENTED IN A VIRTUAL REALITY; U.S. Pat. Appl. No. 62/528,511, filed Jul. 4, 2017, entitled METHOD AND SYSTEM FOR TELEPORTING INTO A PRIVATE VIRTUAL SPACE FROM A COLLABORATIVE VIRTUAL SPACE. The content of each of the related application(s) is hereby incorporated by reference herein in its entirety.

### TECHNICAL FIELD

This disclosure relates to virtual reality (VR), augmented reality (AR), and mixed reality (MR) technologies.

### BRIEF DESCRIPTION OF THE DRAWINGS

FIG. 1A and FIG. 1B depict aspects of a system on which different embodiments are implemented for directing attention of a user to virtual content that is displayable on a user device operated by the user.

FIG. 2 depicts a method for directing attention of a user to virtual content that is displayable on a user device operated by the user.

FIC. 3A through FIG. 3D illustrate different approaches for directing attention of the first user to the first virtual content.

FIG. 4A through FIG. 4C illustrate is a communications sequence diagram.

FIG. 5 depicts a method for providing a private virtual environment that is accessible to a user visiting a public virtual environment

### DETAILED DESCRIPTION

This disclosure relates to different approaches for directing attention of a user to virtual content that is displayable on a user device operated by the user.

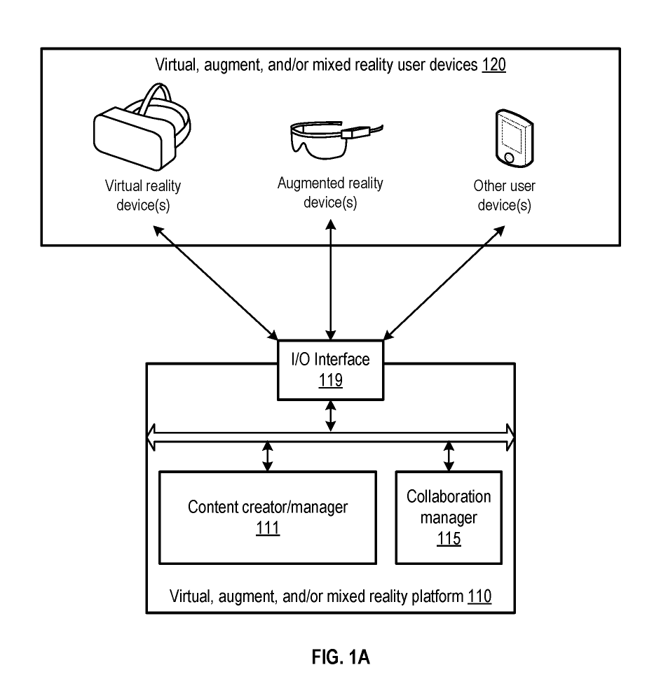

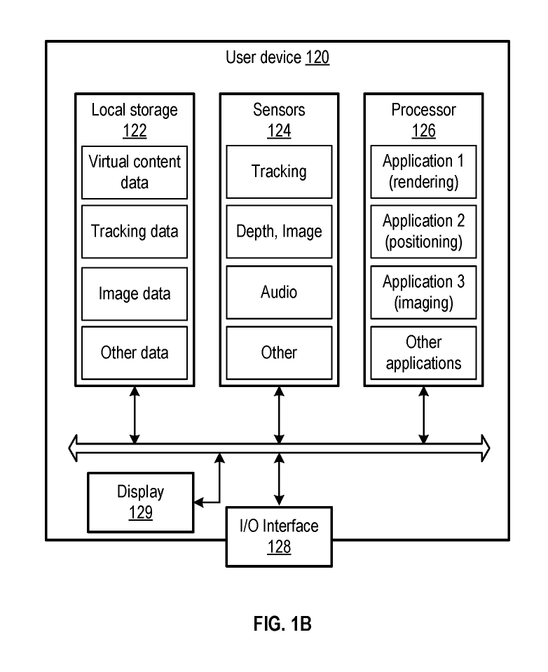

FIG. 1A and FIG. 1B depict aspects of a system on which different embodiments are implemented for directing attention of a user to virtual content that is displayable on a user device operated by the user. The system includes a virtual, augmented, and/or mixed reality platform 110 (e.g., including one or more servers) that is communicatively coupled to any number of virtual, augmented, and/or mixed reality user devices 120 such that data can be transferred between the platform 110 and each of the user devices 120 as required for implementing the functionality described in this disclosure. General functional details about the platform 110 and the user devices 120 are discussed below before particular functions for directing attention of a user to virtual content that is displayable on a user device operated by the user are discussed.

As shown in FIG. 1A, the platform 110 includes different architectural features, including a content creator/manager 111, a collaboration manager 115, and an input/output (I/O) interface 119. The content creator/manager 111 creates and stores visual representations of things as virtual content that can be displayed by a user device 120 to appear within a virtual or physical environment. Examples of virtual content include: virtual objects, virtual environments, avatars, video, images, text, audio, or other presentable data. The collaboration manager 115 provides virtual content to different user devices 120, and tracks poses (e.g., positions and orientations) of virtual content and of user devices as is known in the art (e.g., in mappings of environments, or other approaches). The I/O interface 119 sends or receives data between the platform 110 and each of the user devices 120.

Each of the user devices 120 include different architectural features, and may include the features shown in FIG. 1B, including a local storage component 122, sensors 124, processor(s) 126, an input/output (I/O) interface 128, and a display 129. The local storage component 122 stores content received from the platform 110 through the I/O interface 128, as well as information collected by the sensors 124. The sensors 124 may include: inertial sensors that track movement and orientation (e.g., gyros, accelerometers and others known in the art); optical sensors used to track movement and orientation of user gestures; position-location or proximity sensors that track position in a physical environment (e.g., GNSS, WiFi, Bluetooth or NFC chips, or others known in the art); depth sensors; cameras or other image sensors that capture images of the physical environment or user gestures; audio sensors that capture sound (e.g., microphones); and/or other known sensor(s). It is noted that the sensors described herein are for illustration purposes only and the sensors 124 are thus not limited to the ones described. The processor 126 runs different applications needed to display any virtual content within a virtual or physical environment that is in view of a user operating the user device 120, including applications for: rendering virtual content; tracking the pose (e.g., position and orientation) and the field of view of the user device 120 (e.g., in a mapping of the environment if applicable to the user device 120) so as to determine what virtual content is to be rendered on a display (not shown) of the user device 120; capturing images of the environment using image sensors of the user device 120 (if applicable to the user device 120); and other functions. The I/O interface 128 manages transmissions of data between the user device 120 and the platform 110. The display 129 may include, for example, a touchscreen display configured to receive user input via a contact on the touchscreen display, a semi or fully transparent display, or a non-transparent display. In one example, the display 129 includes a screen or monitor configured to display images generated by the processor 126. In another example, the display 129 may be transparent or semi-opaque so that the user can see through the display 129.

Particular applications of the processor 126 may include: a communication application, a display application, and a gesture application. The communication application may be configured to communicate data from the user device 120 to the platform 110 or to receive data from the platform 110, may include modules that may be configured to send images and/or videos captured by a camera of the user device 120 from sensors 124, and may include modules that determine the geographic location and the orientation of the user device 120 (e.g., determined using GNSS, WiFi, Bluetooth, audio tone, light reading, an internal compass, an accelerometer, or other approaches). The display application may generate virtual content in the display 129, which may include a local rendering engine that generates a visualization of the virtual content. The gesture application identifies gestures made by the user (e.g., predefined motions of the user's arms or fingers, or predefined motions of the user device 120 (e.g., tilt, movements in particular directions, or others). Such gestures may be used to define interaction or manipulation of virtual content (e.g., moving, rotating, or changing the orientation of virtual content).

Examples of the user devices 120 include VR, AR, MR and general computing devices with displays, including: head-mounted displays; sensor-packed wearable devices with a display (e.g., glasses); mobile phones; tablets; or other computing devices that are suitable for carrying out the functionality described in this disclosure. Depending on implementation, the components shown in the user devices 120 can be distributed across different devices (e.g., a worn or held peripheral separate from a processor running a client application that is communicatively coupled to the peripheral).

Having discussed features of systems on which different embodiments may be implemented, attention is now drawn to different processes for directing attention of a user to virtual content that is displayable on a user device operated by the user.

### Directing Attention of a User to Virtual Content that is Displayable on a User Device Operated by the User

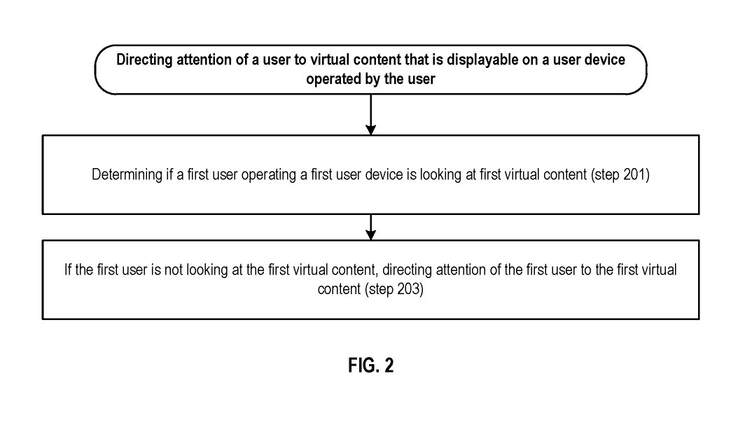

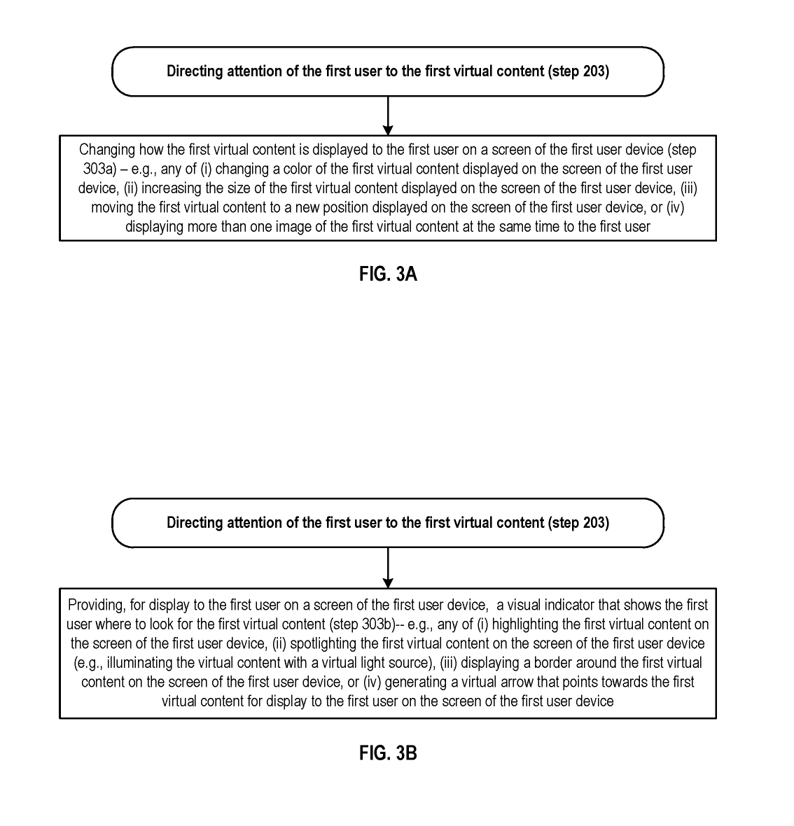

FIG. 2 depicts a method for directing attention of a user to virtual content that is displayable on a user device operated by the user. The user device may be a virtual reality (VR), augmented reality (AR), or other user device operated by the user. Steps of the method comprise: determining if a first user operating a first user device is looking at first virtual content (step 201); and if the first user is not looking at the first virtual content, directing attention of the first user to the first virtual content (step 203). By way of example, the first user device is a virtual reality (VR) user device and the first virtual content is displayed to appear in a virtual environment, or wherein the user device is an augmented reality (AR) user device and the first virtual content is displayed to appear in a real environment.

In one embodiment of the method, determining if the first user is looking at the first virtual content comprises: determining whether an eye gaze of the first user is directed at the first virtual content, wherein the first user is determined to not be looking at the first virtual content if the eye gaze of the first user is not directed at the first virtual content. Examples of determining whether an eye gaze of the first user is directed at the first virtual content include using known techniques, such as (i) determining a point of gaze (where the user is looking) for the eye(s) of the user, and determining if the virtual content is displayed at the point of gaze, (ii) determining a direction of gaze for the eye(s) of the user, and determining if the virtual content is displayed along a the direction of gaze, or (iii) any other technique.

In one embodiment of the method, determining if the first user is looking at the first virtual content comprises: determining whether the first virtual content is displayed on a screen of the first user device, wherein the first user is determined to not be looking at the first virtual content if the first virtual content is not displayed on the screen of the first user device. Examples of determining whether the first virtual content is displayed on a screen of the first user device include using known techniques, such as (i) determining the position of the first virtual content relative to the pose (position, orientation) of the first user in order to determine if the first virtual content is in a field of view of the first user and therefore to be displayed, or (ii) any other known approach.

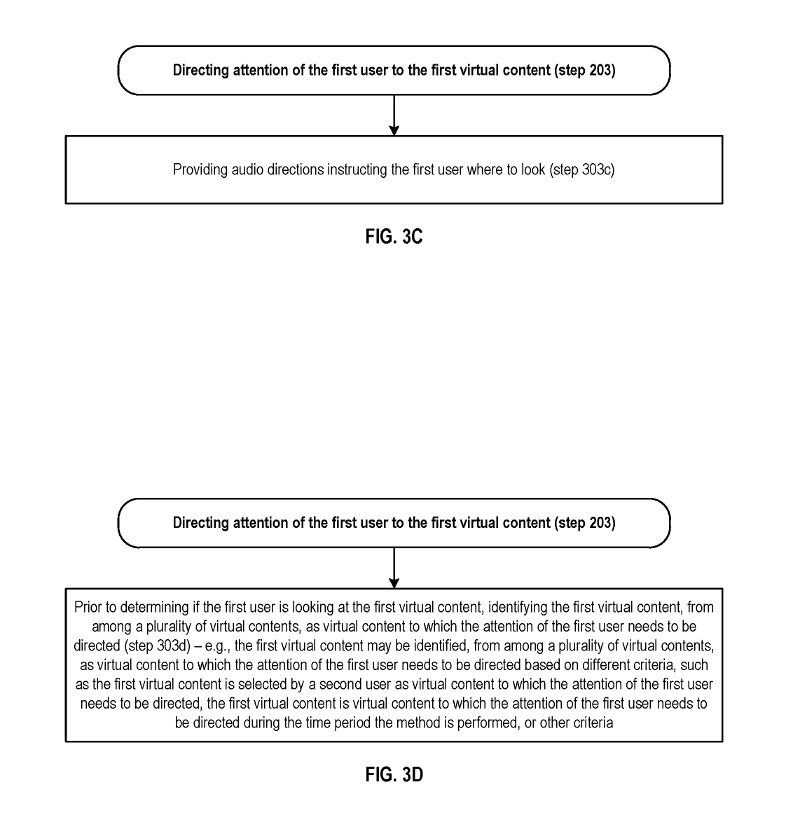

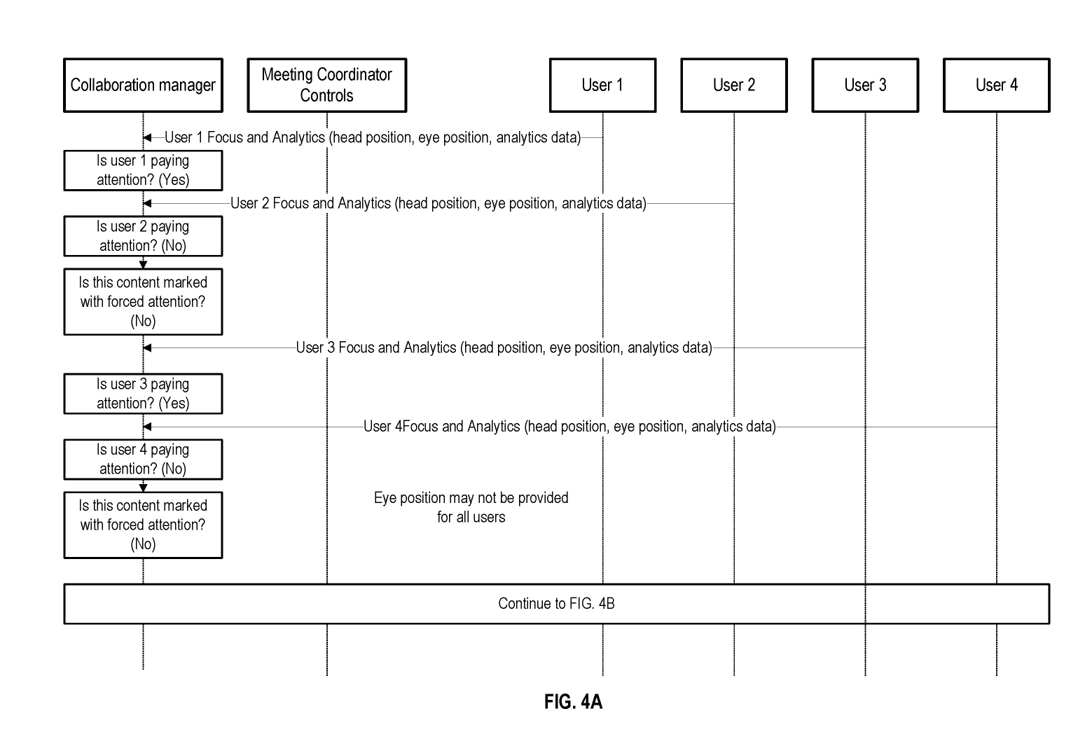

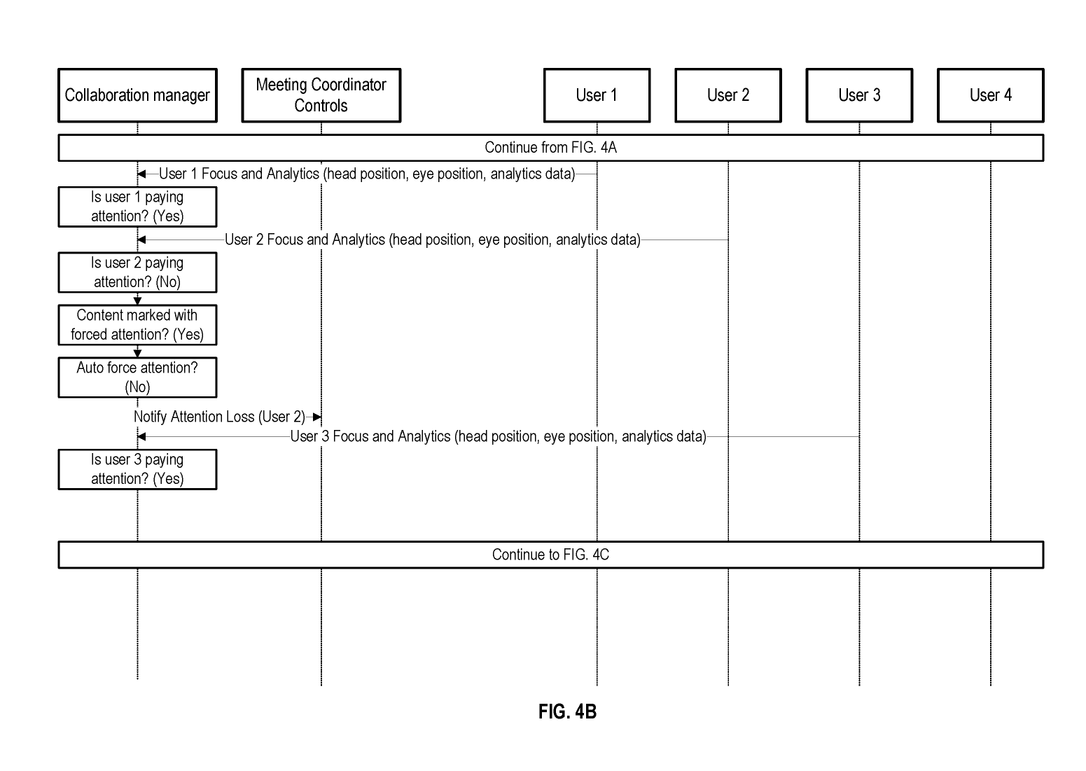

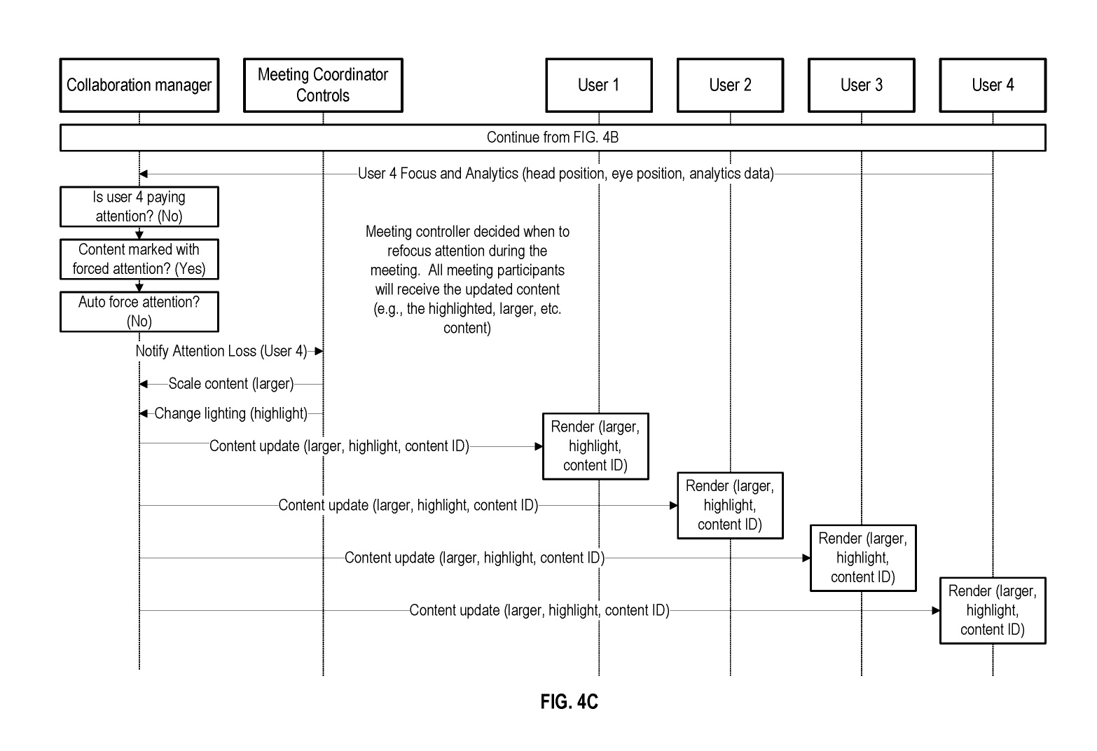

In one embodiment of the method, as shown in FIG. 4A, directing the attention of the first user to the first virtual content comprises: changing how the first virtual content is displayed to the first user on a screen of the first user device (step 303a). In one embodiment of the method, changing how the first virtual content is displayed to the first user on the screen of the first user device comprises any of (i) changing a color of the first virtual content displayed on the screen of the first user device, (ii) increasing the size of the first virtual content displayed on the screen of the first user device, (iii) moving the first virtual content to a new position displayed on the screen of the first user device, or (iv) displaying more than one image of the first virtual content at the same time to the first user.

In one embodiment of the method, as shown in FIG. 3B, directing the attention of the first user to the first virtual content comprises: providing, for display to the first user on a screen of the first user device, a visual indicator that shows the first user where to look for the first virtual content (step 303b). In one embodiment of the method, providing the visual indicator that shows the first user where to look comprises any of (i) highlighting the first virtual content on the screen of the first user device, (ii) spotlighting the first virtual content on the screen of the first user device (e.g., illuminating the virtual content with a virtual light source), (iii) displaying a border around the first virtual content on the screen of the first user device, or (iv) generating a virtual arrow that points towards the first virtual content for display to the first user on the screen of the first user device.

In one embodiment of the method, as shown in FIG. 3C directing the attention of the first user to the first virtual content comprises: providing audio directions instructing the first user where to look (e.g., step 303c). Examples of audio directions include: change eye gaze up/down/left/right, turn head up/down/left/right, look for [description of virtual content spoken by the user], or other.

In one embodiment of the method, the method comprises: determining if the first user is looking at the first virtual content by determining if the first user is looking at a first part of the first virtual content from among a plurality of parts of the first virtual content; and if the first user is not looking at the first part of the first virtual content, directing the attention of the first user to the first virtual content by directing the attention of the first user to the first part of the first virtual content.

In one embodiment of the method, if the first user is looking at the first virtual content, the method comprises: determining if the first user is looking at a first part of the first virtual content from among a plurality of parts of the first virtual content; and if the first user is not looking at the first part of the first virtual content, directing the attention of the first user to the first part of the first virtual content.

In one embodiment of the method, the first user is attending a virtual meeting, and wherein directing attention of the first user to the first virtual content comprises: determining an approach for directing the attention of the first user to the first virtual content during the virtual meeting; and performing the determined approach on the first user device.

In one embodiment of the method, the determined approach is any of (i) changing a color of the first virtual content, (ii) increasing the size of the first virtual content, (iii) moving the first virtual content to a new position, (iv) displaying the first virtual content more than once at the same time; (v) highlighting the first virtual content, (vi) spotlighting the first virtual content, (vii) displaying a border around the first virtual content, or (viii) generating a virtual arrow that points towards the first virtual content.

In one embodiment of the method, the method comprises: informing a second user in the virtual meeting that the first user is not looking at the first virtual content by (i) displaying, on a screen of a second user device operated by the second user, information specifying that the first user is not looking at the first virtual content and (ii) optionally displaying information specifying second virtual content at which the first user is looking; and after informing the second user in the virtual meeting that the first user is not looking at the first virtual content, receiving an instruction to direct the attention of the first user to the first virtual content, wherein the instruction is received from the second user device operated by the second user.

In one embodiment of the method, the instruction to direct the attention of the first user to the first virtual content includes a selection by the second user of the determined approach.

In one embodiment of the method, the method comprises: determining that a third user attending the virtual meeting is looking at the first virtual content; and after determining that the third user is looking at the first virtual content, not performing the determined approach on the third user device.

In one embodiment of the method, the method comprises: determining that a third user attending the virtual meeting is not looking at the first virtual content; and after determining that the third user is not looking at the first virtual content, performing the determined approach on the third user device.

In one embodiment of the method, the method comprises: determining that a second user attending the virtual meeting is looking at the first virtual content; and displaying, on a screen of a third user device operated by a third user, information specifying that the first user is not looking at the first virtual content, and information specifying that the second user is looking at the first virtual content.

In one embodiment of the method, directing the attention of the first user to the first virtual content comprises: prior to determining if the first user is looking at the first virtual content, identifying the first virtual content, from among a plurality of virtual contents, as virtual content to which the attention of the first user needs to be directed. By way of example, the first virtual content may be identified, from among a plurality of virtual contents, as virtual content to which the attention of the first user needs to be directed based on different criteria (e.g., selection by another user, time period, other criteria). In one embodiment, the first virtual content is selected by a second user as virtual content to which the attention of the first user needs to be directed. In another embodiment, the first virtual content is virtual content to which the attention of the first user needs to be directed during the time period the method is performed (e.g., time of day, day of week, week of year, month of year, year, etc.).

One or more non-transitory machine-readable media embodying program instructions that, when executed by one or more machines, cause the one or more machines to implement any of the methods and embodiments described above in this section are also contemplated.

### Providing a Private Virtual Environment That is Accessible to a User Visiting a Public Virtual Environment

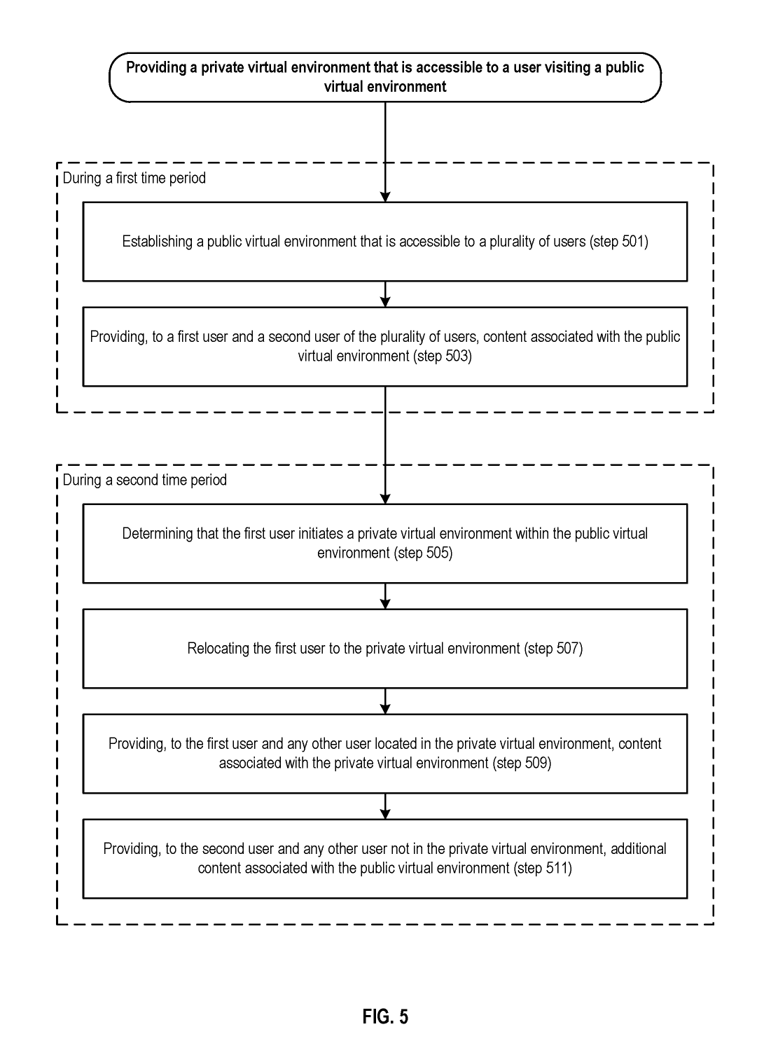

FIG. 5 depicts a method for providing a private virtual environment that is accessible to a user visiting a public virtual environment. The method comprises, during a first time period: establishing a public virtual environment that is accessible to a plurality of users (step 501); and providing, to a first user and a second user of the plurality of users, content associated with the public virtual environment (step 503). The method comprises, during a second time period: determining that the first user initiates a private virtual environment within the public virtual environment (step 505); relocating the first user to the private virtual environment (step 507); providing, to the first user and any other user located in the private virtual environment, content associated with the private virtual environment (step 509); and providing, to the second user and any other user not in the private virtual environment, additional content associated with the public virtual environment (step 511).

In one embodiment of the method, initiation of a private virtual environment occurs by selection of the user (e.g., selection by way of a user manipulation of a user device or peripheral connected thereto, a user gesture, a voice command, or other). The selection may be of a menu option to initiate, a location to which the user moves in the public virtual environment, a virtual object into which the user moves, or another type of selection.

Examples of relocating a user to a virtual environment include displaying the virtual environment to that user and/or or repositioning the user at a location inside the virtual environment (e.g., by teleportation or another approach for moving).

In one embodiment of the method, the public virtual environment is a public virtual meeting that can be attended by a group of users, and the private virtual environment is a private virtual meeting that can be attended by only a subset of users from the group of users. In some embodiments, only attending users can receive content generated for or from within a private virtual environment.

Any number of private virtual environments may exist within the public virtual environment.

Existence of a private virtual environment inside a public virtual environment may include allocating space in the public virtual environment for the private virtual environment to occupy.

A virtual environment can come in different forms, including layers of computer-generated imagery used in virtual reality and/or the same computer-generated imagery that is used in augmented reality.

In one embodiment of the method, the content associated with the public virtual environment includes content generated by one or more of the plurality of users or stored virtual content that is display in the public virtual environment. Content generated by one or more of the plurality of users may include: communications (e.g., audio, text, other communications) among the one or more users, manipulations by the one or more users to displayed virtual content, updated positions of the one or more users after movement by the one or more users, or other content that could be generated by a user within a virtual environment. Examples of manipulations include movement of the virtual content, generated annotations associated with the virtual content, or any other type of manipulation.

In one embodiment of the method, determining that the first user initiates a private virtual environment comprises: detecting a selection of a menu option by the first user.

In one embodiment of the method, determining that the first user initiates a private virtual environment comprises: determining that the first user moved from a position in the public virtual environment to within boundaries of the private virtual environment.

In one embodiment of the method, determining that the first user initiates a private virtual environment comprises: determining that the first user selected a virtual object within which the private virtual environment resides.

In one embodiment of the method, relocating the first user to the private virtual environment comprises teleporting the first user from a position outside the private virtual environment to a position inside the private virtual environment.

In one embodiment of the method, the private virtual environment is inside a virtual object that resides in the public virtual environment.

In one embodiment of the method, the content associated with the private virtual environment includes content generated by any user located in the private virtual environment or stored virtual content that is displayed in the private virtual environment.

In one embodiment of the method, providing content associated with the private virtual environment comprises: not providing the content associated with the private virtual environment to the second user.

In one embodiment of the method, providing content associated with the private virtual environment comprises: providing the content associated with the private virtual environment to the second user only after the first user authorizes the second user to receive the content.

In one embodiment of the method, providing the additional content associated with the public virtual environment comprises: not providing the additional content associated with the public virtual environment to the first user (e.g., based on user selection by the first user.)

In one embodiment of the method, providing the additional content associated with the public virtual environment comprises: providing the additional content associated with the public virtual environment to the first user.

In one embodiment of the method, the public virtual environment is a first virtual meeting of the plurality of users, and wherein the private virtual environment is a second virtual meeting of the first user and any other users from the plurality of users who join the first user in the second virtual meeting.

In one embodiment of the method, method further comprises: storing, in association with the first virtual environment, activity of the plurality of users while inside the public virtual environment during the first time period; and storing, in association with the first virtual environment and the second virtual environment, activity of the first user and any other user while inside the private virtual environment during the second time period. Stored association of user activity inside a virtual environment enables retrieval and playback of that activity at a later time.

In one embodiment of the method, the method further comprises: during a third time period, determining that a third user enters the private virtual environment from the public virtual environment; and during the third time period, providing at least some of the content associated with the private virtual environment to the third user after the third user enters the private virtual environment.

In one embodiment of the method, the method further comprises: determining that the first user wants to make at least a portion of the content associated with the private virtual environment available to the second user while the second user is located in the public virtual environment; after determining that the first user wants to make the portion of the content associated with the private virtual environment available to the second user while the second user is located in the public virtual environment, providing the portion of the content associated with the private virtual environment available to the second user.

Examples of determining that the first user wants to make at least a portion of the content associated with the private virtual environment available to the second user while the second user is located in the public virtual environment include: selection of the content and action to make it available (e.g., moving the to a location outside of the private virtual environment; or selecting a menu option to reveal the content, which removes any visual barriers of the private virtual environment that encase the content, or which displays the content on a screen of the second user.

Examples of providing the portion of the content associated with the private virtual environment available to the second user includes: moving the content to a location outside of the private virtual environment that is in view of the second user; removing any visual barriers of the private virtual environment that encase the content so the second user no longer sees the barriers and instead sees the portion of the content; or displaying the content on a screen of the second user.

In one embodiment of the method, determining that the first user wants to make at least a portion of the content associated with the private virtual environment available to the second user while the second user is located in the public virtual environment comprises: detecting a selection of the portion of the content by the first user, and detecting an action to make the portion of the content available to the second user, wherein the action includes the first user moving the portion of the content to a location outside of the private virtual environment, the first user selecting a menu option to remove one or more visual barriers of the private virtual environment that prevent the second user from viewing the portion of the content, or the first user selecting a menu option to display the portion of the content on a screen of a second user device that is operated by the second user.

In one embodiment of the method, providing the portion of the content associated with the private virtual environment to the second user comprises: moving the portion of the content to a location outside of the private virtual environment that is in view of the second user, removing any visual barriers of the private virtual environment that encase the content so the second user no longer sees the barriers and instead sees the portion of the content, or displaying the portion of the content on a screen of a second user device that is operated by the second user.

One or more non-transitory machine-readable media embodying program instructions that, when executed by one or more machines, cause the one or more machines to implement any of the methods and embodiments described above in this section are also contemplated.

### Other Embodiments Related to Directing Attention of a User to Virtual Content that is Displayable on a User Device Operated by the User

The purpose of embodiments in this section invention is to focus an audience member's attention or the entire audience attention on an object, a presentation or other content in a virtual reality environment. The embodiments of this section provide a toolset to the presenter that empowers the presenter to draw (or force) the audience's attention to the material being presented.

The embodiments of this section provide tools to allow a presenter of VR content to draw the audience's attention to the content by increasing the size of the object, highlighting the object, drawing around the object, spotlighting the object, moving the object and duplicating the object. The invention tracks each audience member's attention based on the position of the member's head and where the member is looking within the VR space. The system uses head tracking and eye tracking to determine the level of interest the member has in the content. The system can (1) provide feedback to the presenter and allow the present to use the tools to refocus the member's attention to the topic/material and (2) automatically apply one or more of the tools to refocus the member's attention.

The system is tracking the head movement and eye movement of the audience participants. The system can detect if the audience members are engaged or are distracted. When the system detects one or more of the audience members are distracted, the system can alert the presenter and allow the presenter to refocus the audience members on the material by doing one of the following: increasing the size of the subject matter, highlighting the subject matter, speaking to the subject matter, changing the color of the subject matter, spotlighting the subject matter, drawing a box/circle/etc., around the subject matter, or duplicating the subject matter and placing the subject matter “clones” around the room (example carousel the subject matter around the room). The presenter can also predefine rules for refocusing the audience members' attention prior to the presentation and allow the system to auto apply the rules when the system detects a lack of attention to the subject matter.

One embodiment, a method for focusing attention on an object or content presented by a VR, AR, MR and/or other user device. The method includes conducting a virtual meeting (e.g., a VR, AR, and/or MR meeting) in a virtual meeting space (e.g., a VR, AR, and/or MR meeting space), the meeting conducted by a presenter and attended by a plurality of attendees, each of the plurality of attendees having a head mounted display (“HMD”) comprising a processor, an IMU, and a display screen, wherein the meeting comprises at least one of virtual content and a virtual object. The method also includes tracking the attention of each attendee of the plurality of attendees based on at least one of HMD tracking and eye tracking. The method also includes informing the presenter of the attention of each attendee of the plurality of attendees. The method also includes focusing the attention of each attendee of the plurality of attendees on one of the virtual content or virtual object in the meeting space.

Alternatively, the method further comprises detecting if an attendee of the plurality of attendees is distracted from a focus of the meeting.

Preferably, focusing the attention of each attendee of the plurality of attendees comprises highlighting the virtual object or the virtual content in the meeting space.

Alternatively, focusing the attention of each attendee of the plurality of attendees comprises increasing the size of the virtual object or virtual content in the meeting space.

Alternatively, focusing the attention of each attendee of the plurality of attendees comprises changing a color of the virtual object or the virtual content in the meeting space.

Alternatively, focusing the attention of each attendee of the plurality of attendees comprises spotlighting the virtual object or the virtual content in the meeting space.

Alternatively, focusing the attention of each attendee of the plurality of attendees comprises drawing a border around the virtual object or the virtual content in the meeting space.

Alternatively, focusing the attention of each attendee of the plurality of attendees comprises multiplying the virtual object or the virtual content in the meeting space and placing each of the multiplied virtual objects or virtual content in various positions in the meeting space.

Alternatively, the method further comprises defining a plurality of rules for focusing the attention of the plurality of attendees in the meeting space, and automatically applying the plurality of rules during the meeting.

Preferably, informing the presenter of the attention of each attendee of the plurality of attendees comprises displaying the virtual object or the virtual content of the attention of each attendee of the plurality of attendees on a display screen of the presenter.

Another embodiment of the present invention is a system for focusing attention on an object or content presented by a VR, AR, MR and/or other user device. The system comprises a collaboration manager at a server, a presenter display device; and a plurality of attendee head mounted display (“HMD”) devices, each of the plurality of attendee HMD devices comprising a processor, an IMU, and a display screen. The collaboration manager is configured to conduct a meeting in a meeting space comprising at least one of virtual content and a virtual object. The collaboration manager is configured to track the attention of each attendee of the plurality of attendees based on at least one of HMD tracking and eye tracking. The collaboration manager is configured to inform the presenter display device of the attention of each of the plurality of attendee HMD devices. The collaboration manager is configured to focus the attention of each of the plurality of attendee HMD devices on one of the virtual content or virtual object in the meeting space.

In different embodiments, the collaboration manager performs any of the methods described herein.

The collaboration manager is preferably configured to detect if an attendee HMD device of the plurality of attendee HMD devices is distracted from a focus of the meeting.

The collaboration manager is configured to define a presenter's plurality of rules for focusing the attention of the plurality of attendees in the VR meeting space, and configured to automatically apply the plurality of rules during the meeting.

Another embodiment of the present invention is a method for focusing attention on an object or content presented by a VR, AR, MR and/or other user device.

The method includes conducting a virtual meeting (e.g., a VR, AR, and/or MR meeting) in a virtual meeting space (e.g., a VR, AR, and/or MR meeting space), the meeting conducted by a presenter and attended by a plurality of attendees, each of the plurality of attendees having a head mounted display (“HMD”) device, wherein the meeting comprises at least one of virtual content and a virtual object. The method also includes tracking the attention of each attendee of the plurality of attendees based on at least one of HMD tracking and eye tracking. The method also includes informing the presenter of the attention of each attendee of the plurality of attendees. The method also includes focusing the attention of each attendee of the plurality of attendees on one of the virtual content or virtual object in the meeting space.

A HMD of at least one attendee of the plurality of attendees is structured to hold a client device comprising a processor, a camera, a memory, a software application residing in the memory, an IMU, and a display screen.

The client device is preferably a personal computer, laptop computer, tablet computer or mobile computing device such as a smartphone.

The display device is preferably selected from the group comprising a desktop computer, a laptop computer, a tablet computer, a mobile phone, an AR headset, and a VR headset.

Another embodiment is a method for identifying and using a hierarchy of targets in an augmented reality (“AR”) environment. The method includes identifying an object in an AR environment, the object focused on by a user wearing an AR head mounted display (“HMD”) device, the AR HMD device comprising a processor, a camera, a memory, a software application residing in the memory, an eye tracking component, an IMU, and a display screen; and identifying a plurality of composite objects of the object on the display screen of the AR HMD device using an identifier.

Another embodiment is a method for identifying and using a hierarchy of targets in a MR environment. The method includes identifying an object in an AR environment, the object focused on by a user wearing a head mounted display (“HMD”) device, the HMD device comprising a processor, a camera, a memory, a software application residing in the memory, an eye tracking component, an IMU, and a display screen; and identifying a plurality of composite objects of the object on the display screen of the HMD device using an identifier.

The identifier is preferably a visual identifier or an audio identifier.

The visual identifier is preferably an arrow, a label, a color change, or a boundary around the composite object.

By way of example, FIG. 4A through FIG. 4C illustrate is a communications sequence diagram in accordance with particular embodiments.

The user interface elements include the capacity viewer and mode changer.

The human eye's performance. 150 pixels per degree (foveal vision). Field of view Horizontal: 145 degrees per eye Vertical 135 degrees. Processing rate: 150 frames per second Stereoscopic vision Color depth: 10 million? (Let's decide on 32 bits per pixel)=470 megapixels per eye, assuming full resolution across entire FOV (33 megapixels for practical focus areas) Human vision, full sphere: 50 Gbits/sec. Typical HD video: 4 Mbits/sec and we would need >10,000 times the bandwidth. HDMI can go to 10 Mbps.

For each selected environment there are configuration parameters associated with the environment that the author must select, for example, number of virtual or physical screens, size/resolution of each screen, and layout of the screens (e.g. carousel, matrix, horizontally spaced, etc). If the author is not aware of the setup of the physical space, the author can defer this configuration until the actual meeting occurs and use the Narrator Controls to set up the meeting and content in real-time.

The following is related to a VR meeting. Once the environment has been identified, the author selects the AR/VR assets that are to be displayed. For each AR/VR asset the author defines the order in which the assets are displayed. The assets can be displayed simultaneously or serially in a timed sequence. The author uses the AR/VR assets and the display timeline to tell a “story” about the product. In addition to the timing in which AR/VR assets are displayed, the author can also utilize techniques to draw the audience's attention to a portion of the presentation. For example, the author may decide to make an AR/VR asset in the story enlarge and/or be spotlighted when the “story” is describing the asset and then move to the background and/or darken when the topic has moved on to another asset.

When the author has finished building the story, the author can play a preview of the story. The preview playout of the story as the author has defined but the resolution and quality of the AR/VR assets are reduced to eliminate the need for the author to view the preview using AR/VR headsets. It is assumed that the author is accessing the story builder via a web interface, so therefore the preview quality should be targeted at the standards for common web browsers.

After the meeting organizer has provided all the necessary information for the meeting, the Collaboration Manager sends out an email to each invitee. The email is an invite to participate in the meeting and also includes information on how to download any drivers needed for the meeting (if applicable). The email may also include a preload of the meeting material so that the participant is prepared to join the meeting as soon as the meeting starts.

The Collaboration Manager also sends out reminders prior to the meeting when configured to do so. Both the meeting organizer or the meeting invitee can request meeting reminders. A meeting reminder is an email that includes the meeting details as well as links to any drivers needed for participation in the meeting.

Prior to the meeting start, the user needs to select the display device the user will use to participate in the meeting. The user can use the links in the meeting invitation to download any necessary drivers and preloaded data to the display device. The preloaded data is used to ensure there is little to no delay experienced at meeting start. The preloaded data may be the initial meeting environment without any of the organization's AR/VR assets included. The user can view the preloaded data in the display device, but may not alter or copy it.

At meeting start time each meeting participant can use a link provided in the meeting invite or reminder to join the meeting. Within 1 minute after the user clicks the link to join the meeting, the user should start seeing the meeting content (including the virtual environment) in the display device of the user's choice. This assumes the user has previously downloaded any required drivers and preloaded data referenced in the meeting invitation.

Each time a meeting participant joins the meeting, the story Narrator (i.e. person giving the presentation) gets a notification that a meeting participant has joined. The notification includes information about the display device the meeting participant is using. The story Narrator can use the Story Narrator Control tool to view each meeting participant's display device and control the content on the device. The Story Narrator Control tool allows the Story Narrator to.

View all active (registered) meeting participants

View all meeting participant's display devices

View the content the meeting participant is viewing

View metrics (e.g. dwell time) on the participant's viewing of the content

Change the content on the participant's device

Enable and disable the participant's ability to fast forward or rewind the content

Each meeting participant experiences the story previously prepared for the meeting. The story may include audio from the presenter of the sales material (aka meeting coordinator) and pauses for Q&A sessions. Each meeting participant is provided with a menu of controls for the meeting. The menu includes options for actions based on the privileges established by the Meeting Coordinator defined when the meeting was planned or the Story Narrator at any time during the meeting. If the meeting participant is allowed to ask questions, the menu includes an option to request permission to speak. If the meeting participant is allowed to pause/resume the story, the menu includes an option to request to pause the story and once paused, the resume option appears. If the meeting participant is allowed to inject content into the meeting, the menu includes an option to request to inject content.

The meeting participant can also be allowed to fast forward and rewind content on the participant's own display device. This privilege is granted (and can be revoked) by the Story Narrator during the meeting.

After an AR story has been created, a member of the maintenance organization that is responsible for the “tools” used by the service technicians can use the Collaboration Manager Front-End to prepare the AR glasses to play the story. The member responsible for preparing the tools is referred to as the tools coordinator.

In the AR experience scenario, the tools coordinator does not need to establish a meeting and identify attendees using the Collaboration Manager Front-End, but does need to use the other features provided by the Collaboration Manager Front-End. The tools coordinator needs a link to any drivers necessary to playout the story and needs to download the story to each of the AR devices. The tools coordinator also needs to establish a relationship between the Collaboration Manager and the AR devices. The relationship is used to communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

Ideally Tsunami would build a function in the VR headset device driver to “scan” the live data feeds for any alarms and other indications of a fault. When an alarm or fault is found, the driver software would change the data feed presentation in order to alert the support team member that is monitoring the virtual NOC.

The support team member also needs to establish a relationship between the Collaboration Manager and the VR headsets. The relationship is used to connect the live data feeds that are to be displayed on the Virtual NOCC to the VR headsets. communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

The story and its associated access rights are stored under the author's account in Content Management System. The Content Management System is tasked with protecting the story from unauthorized access. In the virtual NOCC scenario, the support team member does not need to establish a meeting and identify attendees using the Collaboration Manager Front-End, but does need to use the other features provided by the Collaboration Manager Front-End. The support team member needs a link to any drivers necessary to playout the story and needs to download the story to each of the VR head.

The Asset Generator is a set of tools that allows a Tsunami artist to take raw data as input and create a visual representation of the data that can be displayed in a VR or AR environment. The raw data can be virtually any type of input from: 3D drawings to CAD files, 2D images to power point files, user analytics to real time stock quotes. The Artist decides if all or portions of the data should be used and how the data should be represented. The i Artist is empowered by the tool set offered in the Asset Generator.

The Content Manager is responsible for the storage and protection of the Assets. The Assets are VR and AR objects created by the Artists using the Asset Generator as well as stories created by users of the Story Builder.

Asset Generation Sub-System: Inputs: from anywhere it can: Word, Powerpoint, Videos, 3D objects etc. and turns them into interactive objects that can be displayed in AR/VR (HMD or flat screens). Outputs: based on scale, resolution, device attributes and connectivity requirements.

Story Builder Subsystem: Inputs: Environment for creating the story. Target environment can be physical and virtual. Assets to be used in story; Library content and external content (Word, Powerpoint, Videos, 3D objects etc). Output: Story; =Assets inside an environment displayed over a timeline. User Experience element for creation and editing.

CMS Database: Inputs: Manages The Library, Any asset: AR/VR Assets, MS Office files and other 2D files and Videos. Outputs: Assets filtered by license information.

Collaboration Manager Subsystem. Inputs: Stories from the Story Builder, Time/Place (Physical or virtual)/Participant information (contact information, authentication information, local vs. Geographically distributed). During the gathering/meeting gather and redistribute: Participant real time behavior, vector data, and shared real time media, analytics and session recording, and external content (Word, Powerpoint, Videos, 3D objects etc). Output: Story content, allowed participant contributions Included shared files, vector data and real time media; and gathering rules to the participants. Gathering invitation and reminders. Participant story distribution. Analytics and session recording (Where does it go). (Out-of-band access/security criteria).

Device Optimization Service Layer. Inputs: Story content and rules associated with the participant. Outputs: Analytics and session recording. Allowed participant contributions.

Rendering Engine Obfuscation Layer. Inputs: Story content to the participants. Participant real time behavior and movement. Outputs: Frames to the device display. Avatar manipulation

Real-time platform: The RTP This cross-platform engine is written in C++ with selectable DirectX and OpenGL renderers. Currently supported platforms are Windows (PC), iOS (iPhone/iPad), and Mac OS X. On current generation PC hardware, the engine is capable of rendering textured and lit scenes containing approximately 20 million polygons in real time at 30 FPS or higher. 3D wireframe geometry, materials, and lights can be exported from 3DS MAX and Lightwave 3D modeling/animation packages. Textures and 2D UI layouts are imported directly from Photoshop PSD files. Engine features include vertex and pixel shader effects, particle effects for explosions and smoke, cast shadows blended skeletal character animations with weighted skin deformation, collision detection, Lua scripting language of all entities, objects and properties.

### Other Embodiments Relating to Providing a Private Virtual Environment that is Accessible to a User Visiting a Public Virtual Environment

Motivation for various embodiments described herein is allow one or more users who are participating in a collaborative VR, AR or MR environment to teleport into a VR private space. The user's actions and audio performed in the VR private space are not be seen or heard by the remaining participants in the collaborative space. This is the support for “break out sessions” in the VR, AR and MR realm. The user in the VR private space can return to the collaborative environment at any time.

One embodiment is a method for teleporting into a private virtual space from a collaborative virtual space. The method includes conducting a collaborative session within a virtual environment with a plurality of attendees. The method also includes electing to have a break out session for at least one attendee of the plurality of attendees. The method also includes generating a private virtual space within the virtual environment. The method also includes distributing audio and movement of the at least one attendee to the private virtual space. The method also includes teleporting to the private virtual space. The method also includes conducting a break-out session in the private virtual space for the at least one attendee. The method may include determining the virtual location of the at least one attendee for distribution of content to the collaborative session or the private virtual space.

Another embodiment is a system for teleporting into a private virtual space from a collaborative virtual space. The system comprises a collaboration manager at a server, and a plurality of attendee client devices. The collaboration manager is configured to conduct a collaborative session within a virtual environment with a plurality of attendees. The collaboration manager is configured to receive a request to have a break out session. The collaboration manager is configured to generate a private virtual space within the virtual environment. The collaboration manager is configured to distribute audio and movement of at least one attendee to the private virtual space. The collaboration manager is configured to teleport the at least one attendee to the private virtual space. The collaboration manager is configured to conduct a break-out session in the private virtual space for the at least one attendee. In one embodiment of the system, each of the plurality of attendee client devices comprise at least one of a personal computer, a HMD, a laptop computer, a tablet computer or a mobile computing device.

Yet another embodiment is a system for teleporting into a private virtual space from a collaborative virtual space using a host display device. The system comprises a collaboration manager at a server, a host display device, a plurality of attendee client devices. The collaboration manager is configured to conduct a collaborative session within a virtual environment with a plurality of attendees and at least one host. The collaboration manager is configured to receive a request to have a break out session. The collaboration manager is configured to generate a private virtual space within the environment. The collaboration manager is configured to distribute audio and virtual movement of a host and at least one attendee to the private virtual space. The collaboration manager is configured to teleport the host and the at least one attendee to the private virtual space. The collaboration manager is configured to conduct a break-out session in the private virtual space between the host and the at least one attendee.

Yet another embodiment is a method for teleporting into a private virtual space from a collaborative virtual space with a host attendee. The method includes conducting a collaborative session within a virtual environment with a plurality of attendees and at least one host. The method also includes electing to have a break out session between the host and at least one attendee of the plurality of attendees. The method also includes generating a private virtual space within the virtual environment. The method also includes distributing audio and VR movement of the host and the at least one attendee to the private virtual space. The method also includes teleporting to the private virtual space. The method also includes conducting a break-out session in the private virtual space between the host and the at least one attendee.

The above method(s) can be performed by VR, AR, and/or MR devices. The above method(s) can be performed for VR, AR, and/or MR virtual environments and spaces.

The above system(s) can include VR, AR, and/or MR devices. The above system(s) can operate for VR, AR, and/or MR virtual environments and spaces.

In different embodiments of the above methods and systems, the private virtual space is an object within the virtual environment, or a model of an object within the virtual environment. In one embodiment of the above methods and systems, teleporting comprises at least one of selecting a menu option, gesturing, or selecting an object. In one embodiment of the above methods and systems, the at least one attendee enters the private virtual space alone. In one embodiment of the above methods and systems, a movement and activity of the at least one attendee in the private virtual space is not distributed or visible by the plurality of attendees in the collaboration session. In one embodiment of the above methods and systems, a host is used, where the host is a physical person, a virtual person or a process that directs the at least one attendee through entering into and using the private virtual space. In different embodiments of the above methods and systems, the virtual environment is a VR environment, an AR environment or a MR environment.

The system allows one to many users to participate in collaborative sessions within AR, VR and MR environments. In the collaborative session the users' actions and audio are seen and heard by the rest of the participants in the collaborative session. If one or more users want to have a break out session, those users must leave the collaborative session and create a new AR, VR or MR environment to join. For AR and MR this means, the users must physically move to a private area where they cannot be seen or heard by others. For VR this means, the users must create a new collaborative session that only includes those users as participants. Various embodiments disclosed herein proposes that the break out session is sub component of the original collaborative session within the AR, VR and MR realm.

The break out session can be represented by an object, location or menu option within the AR, VR, and MR realm. When one or more user's elect to enter the break out session, only the users that enter the break out session are included. The system automatically creates a new virtual space the users can interact in. The system distributes the audio and movements of the users in the break out space only to the participants of the break out space. The participants in the original collaborative session may see an indication that the users have left the collaborative space and are in the break out session, but the participants will not see or hear any movement or audio from the break out session. The system is maintaining a parent collaborative session (the original session) and a child session (the break out session). When the system is distributing content to each participant the system must determine if the participant is active in the parent session or the child session and distribute the content accordingly.

The breakout session can be held in a virtual object that was previously a part of the parent virtual space. For example, there may be a virtual mockup for a cargo plane. One or more participants can elect to teleport into the cargo plane. That is, those participants join a breakout session conducted inside the cargo plane. When the participants teleport into the inside of the cargo plane, the participants can see and explore the virtual space inside the cargo plane. They can look out the windows of the cargo plane and see the original space in which the mock up of the cargo plane resided.

In one example of a user scenario, a sales and marketing representative has provided potential customers access to a virtual trade show booth. The virtual tradeshow booth contains market material presented on virtual screens within the booth as well as interactive 3D models to demonstrate the capabilities of the products. One 3D model is a cargo airplane which the sales and marketing representative has preconfigured to be the target of a break out session. That is, the system will spawn a separate virtual environment representing the inside of the cargo plane when one of the trade show booth attendees selects the cargo plane for a breakout.

As each potential customer joins to view the virtual tradeshow booth, the customer can select an avatar or image of himself/herself to represent himself/herself in the virtual space. The system distributes the content of the movement and audio (if applicable) to all the customers viewing the virtual tradeshow booth. Therefore, each customer that is viewing the virtual tradeshow booth can see and hear the other customers viewing the virtual tradeshow booth. In addition, all the customers in the virtual tradeshow booth see the same content being displayed on the virtual screens at the same time. The customers also see the avatars of others viewing the tradeshow booth and their movement around the virtual tradeshow booth. The system may also share/distribute the audio of the tradeshow booth customers. If a customer interacts with a 3D model in the virtual tradeshow booth, the system distributes that interaction with all the tradeshow booth participants. The tradeshow booth participants can see the 3D model being moved/manipulated in real-time.

When a customer decides that he/she would like a more in depth look at the cargo plane, so the sales and marketing representative suggest a break out session inside the cargo plane. The sales and marketing representative and the customer teleport into the cargo plane. They teleport by using a menu option, gesture, or selecting the cargo plane. Upon this action, the system creates a virtual breakout session that is taking place inside the cargo plane. The sales and marketing representative and the customer can walk around inside the cargo plane space and discuss the design of the space without being seen or heard by the other tradeshow booth customers. The system treats the cargo plane space as a separate virtual environment and distributes content and audio for the cargo plane to only the sales and marketing representative and the customer.

Once the sales and marketing representative and the customer are done with the breakout session, they can return to the tradeshow booth and continue to participate in that virtual space. The system removes the virtual space and the associated system resources for the interior of the cargo plane.

One embodiment is a method for teleporting into a private virtual space from a collaborative virtual space. The method includes conducting a collaborative session within a virtual environment with a plurality of attendees. The method also includes electing to have a break out session for at least one attendee of the plurality of attendees. The method also includes generating a private virtual space within the virtual environment. The method also includes distributing audio and VR movement of the at least one attendee to the private virtual space. The method also includes teleporting to the private virtual space. The method also includes conducting a break-out session in the private virtual space for the at least one attendee.

An alternative embodiment is a system for teleporting into a private virtual space from a collaborative virtual space. The system comprises a collaboration manager at a server, and a plurality of attendee client devices. The collaboration manager is configured to conduct a collaborative session within a virtual environment with a plurality of attendees. The collaboration manager is configured to receive a request to have a break out session. The collaboration manager is configured to generate a private virtual space within the virtual environment. The collaboration manager is configured to distribute audio and VR movement of at least one attendee to the private virtual space. The collaboration manager is configured to teleport the at least one attendee to the private virtual space. The collaboration manager is configured to conduct a break-out session in the private virtual space for the at least one attendee.

An alternative embodiment is a method for teleporting into a private virtual space from a MR collaborative virtual space. The method includes conducting a collaborative session within a MR environment with a plurality of attendees. The method also includes electing to have a break out session for at least one attendee of the plurality of attendees. The method also includes generating a private virtual space within the MR environment. The method also includes distributing audio and MR movement of the at least one attendee to the private MR space. The method also includes teleporting to the private MR space. The method also includes conducting a break-out session in the private MR space for the at least one attendee.

An alternative embodiment is a system for teleporting into a private virtual space from a MR collaborative virtual space. The system comprises a collaboration manager at a server, and a plurality of attendee client devices. The collaboration manager is configured to conduct a collaborative session within a MR environment with a plurality of attendees. The collaboration manager is configured to receive a request to have a break out session. The collaboration manager is configured to generate a private virtual space within the MR environment. The collaboration manager is configured to distribute audio and MR movement of at least one attendee to the private virtual space. The collaboration manager is configured to teleport the at least one attendee to the private MR space. The collaboration manager is configured to conduct a break-out session in the private MR space for the at least one attendee.

An alternative embodiment is a method for teleporting into a private virtual space from an AR collaborative virtual space. The method includes conducting a collaborative session within an AR environment with a plurality of attendees. The method also includes electing to have a break out session for at least one attendee of the plurality of attendees. The method also includes generating a private virtual space within the AR environment. The method also includes distributing audio and virtual movement of the at least one attendee to the private virtual space. The method also includes teleporting to the private virtual space. The method also includes conducting a break-out session in the private virtual space for the at least one attendee.

An alternative embodiment is a system for teleporting into a private virtual space from an AR collaborative virtual space. The system comprises a collaboration manager at a server, and a plurality of attendee client devices. The collaboration manager is configured to conduct a collaborative session within an AR environment with a plurality of attendees. The collaboration manager is configured to receive a request to have a break out session. The collaboration manager is configured to generate a private virtual space within the AR environment. The collaboration manager is configured to distribute audio and virtual movement of at least one attendee to the private virtual space. The collaboration manager is configured to teleport the at least one attendee to the private virtual space. The collaboration manager is configured to conduct a break-out session in the private virtual space for the at least one attendee.

An alternative embodiment is a system for teleporting into a private virtual space from a collaborative virtual space using a host display device. The system comprises a collaboration manager at a server, a host display device, a plurality of attendee client devices. The collaboration manager is configured to conduct a collaborative session within a virtual environment with a plurality of attendees and at least one host. The collaboration manager is configured to receive a request to have a break out session. The collaboration manager is configured to generate a private virtual space within the environment. The collaboration manager is configured to distribute audio and virtual movement of a host and at least one attendee to the private virtual space. The collaboration manager is configured to teleport the host and the at least one attendee to the private virtual space. The collaboration manager is configured to conduct a break-out session in the private virtual space between the host and the at least one attendee. The virtual environment is a virtual environment, and AR environment or a MR environment.

An alternative embodiment is a method for teleporting into a private virtual space from a collaborative virtual space with a host attendee. The method includes conducting a collaborative session within a virtual environment with a plurality of attendees and at least one host. The method also includes electing to have a break out session between the host and at least one attendee of the plurality of attendees. The method also includes generating a private virtual space within the virtual environment. The method also includes distributing audio and VR movement of the host and the at least one attendee to the private virtual space. The method also includes teleporting to the private virtual space. The method also includes conducting a break-out session in the private virtual space between the host and the at least one attendee. The virtual environment is a virtual environment, and AR environment or a MR environment.

The method further includes determining the virtual location of the at least one attendee for distribution of content to the collaborative session or the private virtual space.

The private virtual space is preferably an object within the virtual environment. A model of an object is within the virtual environment.

Teleporting preferably comprises at least one of selecting a menu option, gesturing, or selecting an object.

The plurality of virtual assets comprises a whiteboard, a conference table, a plurality of chairs, a projection screen, a model of a jet engine, an model of an airplane, a model of an airplane hanger, a model of a rocket, a model of a helicopter, a model of a customer product, a tool used to edit or change a virtual asset in real time, a plurality of adhesive notes, a projection screen, a drawing board, a 3-D replica of at least one real world object, a 3-D visualization of customer data, a virtual conference phone, a computer, a computer display, a replica of the user's cell phone, a replica of a laptop, a replica of a computer, a 2-D photo viewer, a 3-D photo viewer, 2 2-D image viewer, a 3-D image viewer, a 2-D video viewer, a 3-D video viewer, a 2-D file viewer, a 3-D scanned image of a person, 3-D scanned image of a real world object, a 2-D map, a 3-D map, a 2-D cityscape, a 3-D cityscape, a 2-D landscape, a 3-D landscape, a replica of a real world, physical space, or at least one avatar.

A HMD of at least one attendee of the plurality of attendees is structured to hold a client device comprising a processor, a camera, a memory, a software application residing in the memory, an IMU, and a display screen.

The client device of each of the plurality of attendees comprise at least one of a personal computer, HMD, a laptop computer, a tablet computer or a mobile computing device. A HMD of at least one attendee of the plurality of attendees is structured to hold a client device comprising a processor, a camera, a memory, a software application residing in the memory, an IMU, and a display screen.

The display device is preferably selected from the group comprising a desktop computer, a laptop computer, a tablet computer, a mobile phone, an AR headset, and a virtual reality (VR) headset.

The user interface elements include the capacity viewer and mode changer.

The human eye's performance. 150 pixels per degree (foveal vision). Field of view Horizontal: 145 degrees per eye Vertical 135 degrees. Processing rate: 150 frames per second Stereoscopic vision Color depth: 10 million? (Let's decide on 32 bits per pixel)=470 megapixels per eye, assuming full resolution across entire FOV (33 megapixels for practical focus areas) Human vision, full sphere: 50 Gbits/sec. Typical HD video: 4 Mbits/sec and we would need >10,000 times the bandwidth. HDMI can go to 10 Mbps.

For each selected environment there are configuration parameters associated with the environment that the author must select, for example, number of virtual or physical screens, size/resolution of each screen, and layout of the screens (e.g. carousel, matrix, horizontally spaced, etc). If the author is not aware of the setup of the physical space, the author can defer this configuration until the actual meeting occurs and use the Narrator Controls to set up the meeting and content in real-time.

The following is related to a VR meeting. Once the environment has been identified, the author selects the AR/VR assets that are to be displayed. For each AR/VR asset the author defines the order in which the assets are displayed. The assets can be displayed simultaneously or serially in a timed sequence. The author uses the AR/VR assets and the display timeline to tell a “story” about the product. In addition to the timing in which AR/VR assets are displayed, the author can also utilize techniques to draw the audience's attention to a portion of the presentation. For example, the author may decide to make an AR/VR asset in the story enlarge and/or be spotlighted when the “story” is describing the asset and then move to the background and/or darken when the topic has moved on to another asset.

When the author has finished building the story, the author can play a preview of the story. The preview playout of the story as the author has defined but the resolution and quality of the AR/VR assets are reduced to eliminate the need for the author to view the preview using AR/VR headsets. It is assumed that the author is accessing the story builder via a web interface, so therefore the preview quality should be targeted at the standards for common web browsers.

After the meeting organizer has provided all the necessary information for the meeting, the Collaboration Manager sends out an email to each invitee. The email is an invite to participate in the meeting and also includes information on how to download any drivers needed for the meeting (if applicable). The email may also include a preload of the meeting material so that the participant is prepared to join the meeting as soon as the meeting starts.

The Collaboration Manager also sends out reminders prior to the meeting when configured to do so. Both the meeting organizer or the meeting invitee can request meeting reminders. A meeting reminder is an email that includes the meeting details as well as links to any drivers needed for participation in the meeting.

Prior to the meeting start, the user needs to select the display device the user will use to participate in the meeting. The user can use the links in the meeting invitation to download any necessary drivers and preloaded data to the display device. The preloaded data is used to ensure there is little to no delay experienced at meeting start. The preloaded data may be the initial meeting environment without any of the organization's AR/VR assets included. The user can view the preloaded data in the display device, but may not alter or copy it.

At meeting start time each meeting participant can use a link provided in the meeting invite or reminder to join the meeting. Within 1 minute after the user clicks the link to join the meeting, the user should start seeing the meeting content (including the virtual environment) in the display device of the user's choice. This assumes the user has previously downloaded any required drivers and preloaded data referenced in the meeting invitation.

Each time a meeting participant joins the meeting, the story Narrator (i.e. person giving the presentation) gets a notification that a meeting participant has joined. The notification includes information about the display device the meeting participant is using. The story Narrator can use the Story Narrator Control tool to view each meeting participant's display device and control the content on the device. The Story Narrator Control tool allows the Story Narrator to.

View all active (registered) meeting participants

View all meeting participant's display devices

View the content the meeting participant is viewing

View metrics (e.g. dwell time) on the participant's viewing of the content

Change the content on the participant's device

Enable and disable the participant's ability to fast forward or rewind the content

Each meeting participant experiences the story previously prepared for the meeting. The story may include audio from the presenter of the sales material (aka meeting coordinator) and pauses for Q&A sessions. Each meeting participant is provided with a menu of controls for the meeting. The menu includes options for actions based on the privileges established by the Meeting Coordinator defined when the meeting was planned or the Story Narrator at any time during the meeting. If the meeting participant is allowed to ask questions, the menu includes an option to request permission to speak. If the meeting participant is allowed to pause/resume the story, the menu includes an option to request to pause the story and once paused, the resume option appears. If the meeting participant is allowed to inject content into the meeting, the menu includes an option to request to inject content.

The meeting participant can also be allowed to fast forward and rewind content on the participant's own display device. This privilege is granted (and can be revoked) by the Story Narrator during the meeting.

After an AR story has been created, a member of the maintenance organization that is responsible for the “tools” used by the service technicians can use the Collaboration Manager Front-End to prepare the AR glasses to play the story. The member responsible for preparing the tools is referred to as the tools coordinator.

In the AR experience scenario, the tools coordinator does not need to establish a meeting and identify attendees using the Collaboration Manager Front-End, but does need to use the other features provided by the Collaboration Manager Front-End. The tools coordinator needs a link to any drivers necessary to playout the story and needs to download the story to each of the AR devices. The tools coordinator also needs to establish a relationship between the Collaboration Manager and the AR devices. The relationship is used to communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

Ideally Tsunami would build a function in the VR headset device driver to “scan” the live data feeds for any alarms and other indications of a fault. When an alarm or fault is found, the driver software would change the data feed presentation in order to alert the support team member that is monitoring the virtual NOC.

The support team member also needs to establish a relationship between the Collaboration Manager and the VR headsets. The relationship is used to connect the live data feeds that are to be displayed on the Virtual NOCC to the VR headsets, communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

The story and its associated access rights are stored under the author's account in Content Management System. The Content Management System is tasked with protecting the story from unauthorized access. In the virtual NOCC scenario, the support team member does not need to establish a meeting and identify attendees using the Collaboration Manager Front-End, but does need to use the other features provided by the Collaboration Manager Front-End. The support team member needs a link to any drivers necessary to playout the story and needs to download the story to each of the VR head.

The Asset Generator is a set of tools that allows a Tsunami artist to take raw data as input and create a visual representation of the data that can be displayed in a VR or AR environment. The raw data can be virtually any type of input from: 3D drawings to CAD files, 2D images to power point files, user analytics to real time stock quotes. The Artist decides if all or portions of the data should be used and how the data should be represented. The i Artist is empowered by the tool set offered in the Asset Generator.

The Content Manager is responsible for the storage and protection of the Assets. The Assets are VR and AR objects created by the Artists using the Asset Generator as well as stories created by users of the Story Builder.

Asset Generation Sub-System: Inputs: from anywhere it can: Word, Powerpoint, Videos, 3D objects etc. and turns them into interactive objects that can be displayed in AR/VR (HMD or flat screens). Outputs: based on scale, resolution, device attributes and connectivity requirements.

Story Builder Subsystem: Inputs: Environment for creating the story. Target environment can be physical and virtual. Assets to be used in story; Library content and external content (Word, Powerpoint, Videos, 3D objects etc). Output: Story; =Assets inside an environment displayed over a timeline. User Experience element for creation and editing.

CMS Database: Inputs: Manages The Library, Any asset: AR/VR Assets, MS Office files and other 2D files and Videos. Outputs: Assets filtered by license information.

Collaboration Manager Subsystem. Inputs: Stories from the Story Builder, Time/Place (Physical or virtual)/Participant information (contact information, authentication information, local vs. Geographically distributed). During the gathering/meeting gather and redistribute: Participant real time behavior, vector data, and shared real time media, analytics and session recording, and external content (Word, Powerpoint, Videos, 3D objects etc). Output: Story content, allowed participant contributions Included shared files, vector data and real time media; and gathering rules to the participants. Gathering invitation and reminders. Participant story distribution. Analytics and session recording (Where does it go). (Out-of-band access/security criteria).

Device Optimization Service Layer. Inputs: Story content and rules associated with the participant. Outputs: Analytics and session recording. Allowed participant contributions.

Rendering Engine Obfuscation Layer. Inputs: Story content to the participants. Participant real time behavior and movement. Outputs: Frames to the device display. Avatar manipulation

Real-time platform: The RTP This cross-platform engine is written in C++ with selectable DirectX and OpenGL renderers. Currently supported platforms are Windows (PC), iOS (iPhone/iPad), and Mac OS X. On current generation PC hardware, the engine is capable of rendering textured and lit scenes containing approximately 20 million polygons in real time at 30 FPS or higher. 3D wireframe geometry, materials, and lights can be exported from 3DS MAX and Lightwave 3D modeling/animation packages. Textures and 2D UI layouts are imported directly from Photoshop PSD files. Engine features include vertex and pixel shader effects, particle effects for explosions and smoke, cast shadows blended skeletal character animations with weighted skin deformation, collision detection, Lua scripting language of all entities, objects and properties.

### Other Aspects

Each method of this disclosure can be used with virtual reality (VR), augmented reality (AR), and/or mixed reality (MR) technologies. Virtual environments and virtual content may be presented using VR technologies, AR technologies, and/or MR technologies. By way of example, a virtual environment in AR may include one or more digital layers that are superimposed onto a physical (real world environment).

The user of a user device may be a human user, a machine user (e.g., a computer configured by a software program to interact with the user device), or any suitable combination thereof (e.g., a human assisted by a machine, or a machine supervised by a human)

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed. By way of example, machines may include one or more computing device(s), processor(s), controller(s), integrated circuit(s), chip(s), system(s) on a chip, server(s), programmable logic device(s), other circuitry, and/or other suitable means described herein or otherwise known in the art. One or more machines that are configured to perform the methods or operations comprising the steps of any methods described herein are contemplated. Systems that include one or more machines and the one or more non-transitory machine-readable media embodying program instructions that, when executed by the one or more machines, cause the one or more machines to perform or implement operations comprising the steps of any methods described herein are also contemplated. Systems comprising one or more modules that perform, are operable to perform, or adapted to perform different method steps/stages disclosed herein are also contemplated, where the modules are implemented using one or more machines listed herein or other suitable hardware.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Processes described above and shown in the figures include steps that are performed at particular machines. In alternative embodiments, those steps may be performed by other machines (e.g., steps performed by a server may be performed by a user device if possible, and steps performed by the user device may be performed by the server if possible).

When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

1. A method for directing attention of a user to virtual content that is displayable on a virtual reality (VR), augmented reality (AR), or other user device operated by the user, the method comprising:
determining if a first user operating a first user device is looking at first virtual content; and
if the first user is not looking at the first virtual content, directing attention of the first user to the first virtual content.

2. The method of claim 1, wherein determining if the first user is looking at the first virtual content comprises:
determining whether an eye gaze of the first user is directed at the first virtual content,
wherein the first user is determined to not be looking at the first virtual content if the eye gaze of the first user is not directed at the first virtual content.

3. The method of claim 1, wherein determining if the first user is looking at the first virtual content comprises:
determining whether the first virtual content is displayed on a screen of the first user device,
wherein the first user is determined to not be looking at the first virtual content if the first virtual content is not displayed on the screen of the first user device.

4. The method of claim 1, wherein directing the attention of the first user to the first virtual content comprises:
changing how the first virtual content is displayed to the first user on a screen of the first user device.

5. The method of claim 4, wherein changing how the first virtual content is displayed to the first user on the screen of the first user device comprises any of (i) changing a color of the first virtual content displayed on the screen of the first user device, (ii) increasing the size of the first virtual content displayed on the screen of the first user device, (iii) moving the first virtual content to a new position displayed on the screen of the first user device, or (iv) displaying more than one image of the first virtual content at the same time to the first user.

6. The method of claim 1, wherein directing the attention of the first user to the first virtual content comprises:
providing, for display to the first user on a screen of the first user device, a visual indicator that shows the first user where to look for the first virtual content.

7. The method of claim 6, wherein providing the visual indicator that shows the first user where to look comprises any of (i) highlighting the first virtual content on the screen of the first user device, (ii) spotlighting the first virtual content on the screen of the first user device, (iii) displaying a border around the first virtual content on the screen of the first user device, or (iv) generating a virtual arrow that points towards the first virtual content for display to the first user on the screen of the first user device.

8. The method of claim 1, wherein directing the attention of the first user to the first virtual content comprises:
providing audio directions instructing the first user where to look.

9. The method of claim 1, wherein the method comprises:
determining if the first user is looking at the first virtual content by determining if the first user is looking at a first part of the first virtual content from among a plurality of parts of the first virtual content; and
if the first user is not looking at the first part of the first virtual content, directing the attention of the first user to the first virtual content by directing the attention of the first user to the first part of the first virtual content.

10. The method of claim 1, wherein the method comprises:
if the first user is looking at the first virtual content:
determining if the first user is looking at a first part of the first virtual content from among a plurality of parts of the first virtual content; and
if the first user is not looking at the first part of the first virtual content, directing the attention of the first user to the first part of the first virtual content.

11. The method of claim 1, wherein the first user is attending a virtual meeting, and wherein directing attention of the first user to the first virtual content comprises:
determining an approach for directing the attention of the first user to the first virtual content during the virtual meeting; and
performing the determined approach on the first user device.

12. The method of claim 11, wherein the determined approach is any of (i) changing a color of the first virtual content, (ii) increasing the size of the first virtual content, (iii) moving the first virtual content to a new position, (iv) displaying the first virtual content more than once at the same time; (v) highlighting the first virtual content, (vi) spotlighting the first virtual content, (vii) displaying a border around the first virtual content, or (viii) generating a virtual arrow that points towards the first virtual content.

13. The method of claim 11, wherein the method comprises:
informing a second user in the virtual meeting that the first user is not looking at the first virtual content by (i) displaying, on a screen of a second user device operated by the second user, information specifying that the first user is not looking at the first virtual content and (ii) optionally displaying information specifying second virtual content at which the first user is looking; and
after informing the second user in the virtual meeting that the first user is not looking at the first virtual content, receiving an instruction to direct the attention of the first user to the first virtual content, wherein the instruction is received from the second user device operated by the second user.

14. The method of claim 11, wherein the instruction to direct the attention of the first user to the first virtual content includes a selection by the second user of the determined approach.

15. The method of claim 12, wherein the method comprises:
determining that a third user attending the virtual meeting is looking at the first virtual content; and
after determining that the third user is looking at the first virtual content, not performing the determined approach on the third user device.

16. The method of claim 12, wherein the method comprises:
determining that a third user attending the virtual meeting is not looking at the first virtual content; and
after determining that the third user is not looking at the first virtual content, performing the determined approach on the third user device.

17. The method of claim 11, wherein the method comprises:
determining that a second user attending the virtual meeting is looking at the first virtual content; and
displaying, on a screen of a third user device operated by a third user, information specifying that the first user is not looking at the first virtual content, and information specifying that the second user is looking at the first virtual content.

18. The method of claim 1, wherein directing the attention of the first user to the first virtual content comprises:
prior to determining if the first user is looking at the first virtual content, identifying the first virtual content, from among a plurality of virtual contents, as virtual content to which the attention of the first user needs to be directed.

19. One or more non-transitory machine-readable media embodying program instructions that, when executed by one or more machines, cause the one or more machines to implement the method of claim 1.
